(19) United States
(12) Patent Application Publication
(10) Pub. No.: US 2018/0211334 A1
(43) Pub. Date: Jul. 26, 2018

(54) Re-Organization of Displayed Images Based On Purchase Histories

(71) Applicant: International Business Machines Corporation, Armonk, NY (US)

(72) Inventors: Ben Z. Akselrod, Givat Shmuel (IL); Anthony Di Loreto, Markham (CA); Steve McDuff, Markham (CA); Kyle D. Robeson, North York (CA)

(21) Appl. No.: 15/415,494

(22) Filed: Jan. 25, 2017

(51) Int. Cl. G06Q 50/00; G06Q 30/06; G06F 17/30

(52) U.S. Cl. CPC G06Q 50/01; G06F 17/30905; G06Q 30/0631

(57) ABSTRACT

A computer-implemented method, system and computer program product for re-organizing images to be displayed to a user are provided. The computer-implemented method, system and computer program product send images to be displayed to the user during a browsing session organized based on a profile of the user. Responsive to receiving a request from the user for recommended images, where the recommended images are based on a purchase history of the user, the computer-implemented method, system and computer program product re-organize the images that were sent to include the recommended images, and send the re-organized images to be displayed to the user.

### BACKGROUND

### 1. Field

The present disclosure relates to social networking systems, and more particularly, to a computer-implemented method, system and computer program product for re-organizing images to be displayed to a user on a social networking system based on a purchase history of the user.

### 2. Description of the Related Art

Social networking sites or systems are increasingly being used in electronic commerce (i.e., e-commerce) as a starting point to shop for goods and services. For example, users on a social networking site often communicate among themselves regarding products that they have bought or with which they have had experience. Further, users on social networking sites may at times publish information about those goods and services. The information may be in the form of service or product reviews and/or recommendations, service or product ratings, sharing of service or product information, or other suitable types of information. This facilitates other users that may be interested in a service or product to obtain information about the service or product by searching the social networking sites for the published information. Upon reading the information, the users may decide as to whether or not they ought to buy the products or services. Note that, henceforth, site and system will be used interchangeably.

However, there usually is not much interaction between social networking systems and e-commerce systems to enhance user on-line shopping experience.

### SUMMARY

The present disclosure provides a computer-implemented method, system and computer program product for re-organizing images to be displayed to a user. The computer-implemented method, system and computer program product send images to be displayed to the user during a browsing session, and the images are organized based on a profile of the user. The computer-implemented method, system and computer program product receive a request from the user for recommended images, the recommended images being based on a purchase history of the user, responsive to the received request, re-organizes the images sent to include the recommended images, and sends the re-organized images to be displayed to the user.

In one embodiment, the purchase history is from an e-commerce site. In a yet another embodiment, the purchase history is from a plurality of e-commerce sites.

In yet a further embodiment, the purchase history includes a wish list. In another embodiment, the profile is based on a group consisting of preferences, browsing history, search history, locations and travel patterns of the user.

In one particular embodiment, the recommended images are from an e-commerce site. And in yet another particular embodiment, the purchase history is from a plurality of e-commerce sites.

### BRIEF DESCRIPTION OF THE DRAWINGS

FIG. 1 is a pictorial representation of a network of data processing systems in which an illustrative embodiment may be implemented;

FIG. 2 is a block diagram of a data processing system that may be implemented as a server in accordance with an illustrative embodiment;

FIG. 3 is a block diagram of a data processing system that may be implemented as a client in accordance with an illustrative embodiment;

FIG. 4 is a flowchart of a process that may be used by a social networking system to send images to be displayed to a user at a client system in accordance with an illustrative embodiment;

FIG. 5 is a flowchart of a process that may be used by an e-commerce system to send information about users to a social networking system in accordance with an illustrative embodiment; and

FIG. 6 is a flowchart of an alternative process that may be used by a social networking system to send images to be displayed to a user at a client system in accordance with an illustrative embodiment.

### DETAILED DESCRIPTION

The present invention may be a system, a method, and/or a computer program product at any possible technical detail level of integration. The computer program product may include a computer-readable storage medium or media having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing devices. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing devices. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function or act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions or acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowcharts or block diagrams may represent a module, a segment, or a portion of instructions, which comprises one or more executable instructions for implementing the specified logical function or functions. In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

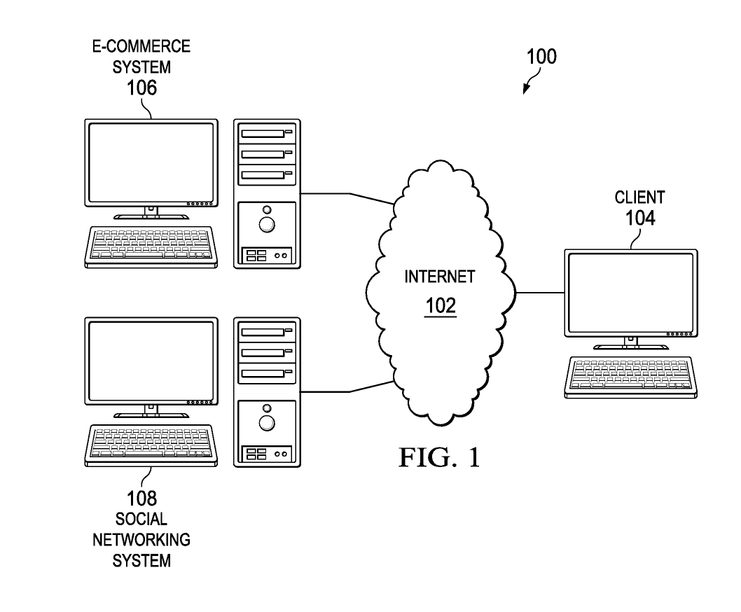

With reference now to the figures, FIG. 1 depicts a pictorial representation of a network of data processing systems of the present disclosure. Network data processing system 100 includes e-commerce system 106, social networking system 108 and client 104 interconnected via network 102. Network 102 can be a local area network, wide area network, cellular network, personal area network, or a combination thereof, and the connection to and/or between network 102 and the data processing systems can be wired or wireless or a combination thereof. For purposes of discussion, network 102 is indicated as a single collective component for simplicity. However, it is appreciated that network 102 can comprise one or more direct connections to other devices as well as a more complex set of interconnections as can exist within a wide area network, such as the Internet.

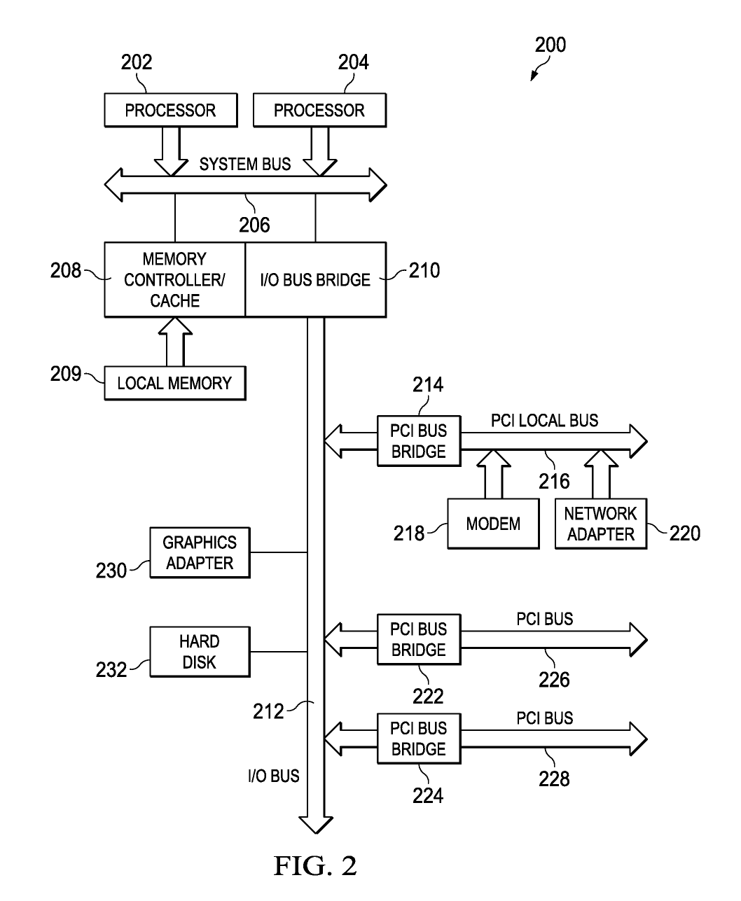

Referring to FIG. 2, a block diagram of a data processing system that may be implemented as a server, such as e-commerce system 106 and social networking system 108 in FIG. 1, is depicted in accordance with a preferred embodiment of the present disclosure. Data processing system 200 may be a symmetric multiprocessor (SMP) system including a plurality of processors, including processor 202 and processor 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214, connected to I/O bus 212, provides an interface to PCI local bus 216. A number of modems may be connected to PCI local bus 216. Typical PCI bus implementations will support four PCI expansion slots or add-in connectors. Communications links to client 104, shown in FIG. 1, or to other computer systems (not shown) in FIG. 1 may be provided through modem 218 and network adapter 220 connected to PCI local bus 216 through add-in boards.

Additional PCI bus bridges, such as PCI bus bridge 222 and PCI bus bridge 224, provide interfaces for additional PCI local bus 226 and PCI local bus 228, from which additional modems or network adapters may be supported. In this manner, data processing system 200 allows connections to multiple computer systems. A memory-mapped graphics adapter 230 and hard disk 232 may also be connected to I/O bus 212 as depicted, either directly or indirectly.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

Those of ordinary skill in the art will appreciate that the hardware depicted in FIG. 2 may vary. For example, other peripheral devices, such as optical disk drives, universal serial bus (USB) drives and the like, also may be used, in addition to or in place of, the hardware depicted. Thus, the depicted example is not meant to imply architectural limitations.

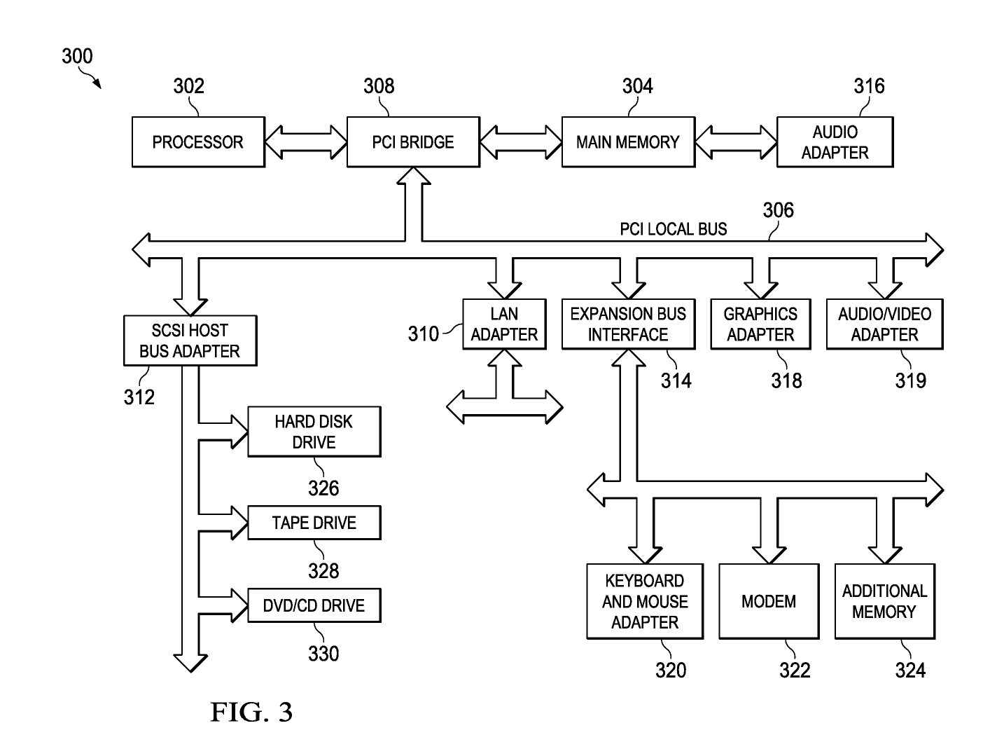

With reference now to FIG. 3, a block diagram illustrating a data processing system is depicted in which the present disclosure may be implemented. Data processing system 300 is an example of a client computer, such as client 104 of FIG. 1. Data processing system 300 employs a peripheral component interconnect (PCI) local bus architecture. Although the depicted example employs a PCI bus, other bus architectures such as accelerated graphics port (AGP) and industry standard architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and DVD/CD drive 330. Typical PCI local bus implementations will support three or four PCI expansion slots or add-in connectors.

An operating system runs on processor 302 and is used to coordinate and provide control of various components within data processing system 300 in FIG. 3. The operating system may be an open source operating system, such as Linux, or a Microsoft Windows® operating system or the like. Windows is a trademark of Microsoft Corp. An object oriented programming system, such as Java, may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary, depending on the implementation. Other internal hardware or peripheral devices, such as flash ROM (or an equivalent nonvolatile memory) or optical disk drives, USB drives and the like, may be used in addition to or in place of the hardware depicted in FIG. 3. Also, the processes of the present disclosure may be applied to a multiprocessor data processing system.

The depicted example in FIG. 3 and above-described examples are not meant to imply architectural limitations. For example, data processing system 300 may also be a mobile device such as a personal digital assistant (PDA) device, a cellular telephone, a tablet, a notebook, a laptop and other suitable types of devices. Data processing system 300 also may be a kiosk or a Web appliance.

Returning to FIG. 1, e-commerce system 106 may be an e-commerce system running a WebSphere Application Server, a product of IBM Corporation. Thus, a user may be using client 104 to interact with e-commerce system 106, and/or social networking system 108.

As is well known, social networking sites require that users register and log into their account using a user identification (ID) and password to use or access the facilities of the sites. Likewise, e-commerce sites require that users or shoppers register and log into their account using a user ID and password to actually make a purchase and/or put an item (i.e., service or product) into their wish list.

According to the disclosure, if the user at client 104 uses the same user ID and/or password to log into both social networking system 108 and e-commerce system 106, and if the user provides the proper permission to either or both social networking system 108 and e-commerce system 106, then social networking system 108 and e-commerce system 106 may share information about the user. Further, when providing the permission, the user may indicate to social networking system 108 one or more e-commerce systems 106 with which the user may want social networking system 108 to interact. Likewise, the user may indicate to e-commerce system 106 one or more social networking systems 108 with which e-commerce system 106 may interact.

If the user does not use the same user ID and/or password to access both e-commerce system 106 and social networking system 108, or if the user does not want to provide the user ID and/or password that the user uses to access either or both e-commerce system 106 and social networking system 108, the user may provide a particular user ID and/or password that e-commerce system 106 and social networking system 108 may use to exchange information about the user. In such a case, the permission may be implied.

Specifically, if social networking system 108 is able to identify a particular user of e-commerce system 106, and/or vice versa, and social networking system 108 and/or e-commerce system 106 has secured the proper permission from the user for social networking system 108 and e-commerce system 106 to exchange information about the user, then social networking system 108 and e-commerce system 106 may do so.

In any event, Pinterest.com (i.e., Pinterest) will be used as social networking system 108 and Amazon.com (i.e., Amazon) will be used as e-commerce system 106 to further explain the disclosure. However, it should be understood that any social networking system (e.g., Facebook.com, Instagram.com, etc.) and any e-commerce system (i.e., ebay.com, IBM.com, etc.) are well within the realm of the disclosure. Thus, the use of Pinterest and Amazon in explaining the disclosure is only for illustrative purposes.

Pinterest is a social networking site that allows users to upload, save, sort, and manage images and videos. The images and videos are known as “pins” and they are assembled on boards known as “pinboards”. More particularly, Pinterest allows users to visually share, and discover new interests by posting images or videos to their own or other users' pinboards and browsing what other users have pinned.

Accordingly, a user at client 104 may log into his or her account on Pinterest (i.e., social networking system 108) to browse or search for any particular image on a subject matter. Likewise, the user may log into Amazon (i.e., e-commerce system 106) to purchase or put into a wish list, a product in which the user might have been interested. Suppose, for example, the user purchases a television set from Amazon, then Amazon may inform Pinterest of the purchase. Upon receiving the information from Amazon, Pinterest may check to see what the user has been searching for or browsing on Pinterest, Suppose that the user had done searches for or browsed blu-ray disks of movies, Pinterest may determine that the user is interested in watching movies. Hence, when the user logs onto Pinterest, Pinterest may filter up or re-organizes the images displayed to the user, such that images of popcorns, or sodas or anything that may make movie viewing more enjoyable to a user are displayed to the user.

As another example, if the user has purchased a lot of dog food and pet supplies and Pinterest determines that the user has been browsing images of different types of dogs, then Pinterest may decide to filter up images of dog food and pet supplies based on those different types of dogs. Therefore, only images of dog food and pet supplies that are more suitable to the types of dogs the user has been browsing or searching for would be displayed to the user.

Hence, based on the purchase history or wish list of a user received from an e-commerce site, along with preferences, user profiles, search and browsing histories, as well as other marketing factors, such as shopper location (city, store, country, etc. . . . ), travel patterns and other suitable types of information, Pinterest may determine how best to organize and/or re-organize the images that are displayed to the user to enhance the experience of the user on Pinterest.

Therefore, unlike sponsored link promotions where the primary objective is to drive up sales, the primary objective, according to the disclosure, is to display items in which users may be interested as gleaned from purchase histories/wish lists and/or search and browsing histories and/or preferences and/or profiles, and/or location (city, store, country, etc. . . . ), travel patterns and other suitable types of information for the users.

In this scenario, based on the television purchase, Pinterest may also display images of television stands, wall brackets or mounts, blu-ray disks, DVDs, etc. if Pinterest determines that the user may be interested in such items. All displayed images may be linked to an e-commerce site or sites that sell the items shown in the images such that when the user clicks on an image, the user may be taken to one or more e-commerce sites. For example, if an item is available at more than one e-commerce site, upon clicking on the image of the item, the user may be presented with a choice of e-commerce sites where the item may be available for purchase.

Instead of sending the purchase or wish list information to Pinterest so that Pinterest may determine which images to display to the user, Amazon may do so itself. In such cases, Amazon may provide the images of the popcorns, sodas, television stands, wall brackets, mounts, blu-ray disks, DVDs, etc. to Pinterest so that Pinterest may send the images to be displayed to the user. In this particular case, the images may all be linked back to Amazon.

One aspect of the disclosure is that Pinterest may be receiving purchase history of a user from a plurality of e-commerce sites. Pinterest may then consolidate the different purchase histories of the user in order to properly organize the pins or images that are displayed to the user. As an example, the user's purchase history of the dog food and supplies may have come from two or more e-commerce sites (e.g., Amazon, ebay, etc.). It may have been after that Pinterest has consolidated the different purchase histories of the user that Pinterest has determined that the user had been buying a lot of dog food and pet supplies.

If, as mentioned above, Amazon were to instead be the one to figure out what items that Pinterest ought to display to the user, then Pinterest may send all purchase histories received from all the different e-commerce sites (i.e., ebay, IBM, etc.) about a user to Amazon. Upon receiving that information, Amazon may then use an algorithm to determine what items that Amazon may want to cross-sell to the user. The items may then be sent to Pinterest so that Pinterest may send the items to be displayed to the user.

In an alternative embodiment, instead of the e-commerce sites sending the user information to a social networking site, the social networking site may send a query to each e-commerce site for the information. This allows the information to stay within the original organization, which could then control the information at a more granular level if desired.

Note that the disclosure is not restricted to only e-commerce stores, brick and mortar stores may be included also, so long as the brick and mortar stores can accurately identify a client as one of the users of a social networking system. For example, some brick and mortar stores may provide a client a store card or request a client's e-mail address, or other types of information about the client so that the store may track the client's purchase history. In such a case, if the client indicates to a brick and mortar store the social networking sites with which to interact, the brick and mortar store may send the tracking information to the social networking systems. If a brick and mortar store receives a list of all purchase histories and/or wish lists of a client from one or more social networking sites, the brick and mortar store may send e-mail messages to the client that includes images of items the brick and mortar store deem to be interesting to the client. The images may be based on the list of purchase histories and/or wish lists etc. of the user.

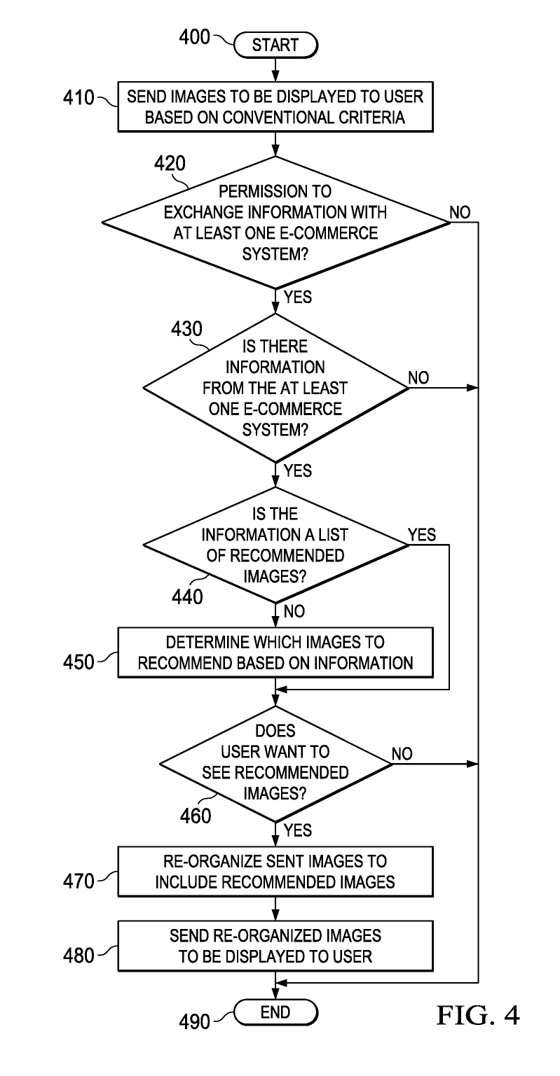

FIG. 4 is a flowchart of a process that may be used by a social networking system to send images to be displayed to a user at a client system, in accordance with an illustrative embodiment. The images may be of goods, services, people, animals, objects and other types of suitable images. The process starts when the user is logged onto the networking system (block 400). At that point, images of items that are usually displayed to the user based on conventional criteria (i.e., user preferences, user profiles, search and browsing histories of the user, user locations and the like) are sent to the client system to be displayed to the user (block 410). The process then determines whether or not the user has given permission for the social networking system to exchange information with at least one e-commerce system (block 420). If not, the process terminates (block 490). If, on the other hand, the user has given permission for the exchange of information, then the process makes another determination as to whether the social networking system has received information about the user from the at least one e-commerce system (block 430). If not, again the process terminates (block 490). If the social networking system has received information about the user from the at least one e-commerce system, then the process determines whether the information is a list of recommended images that are to be displayed to the user (block 440). If so, the process continues on to block 460.

As mentioned above, the at least one e-commerce system may decide to provide the images that are to be displayed to users instead of sending the users' purchase history and/or wish list to the social networking system. Whether the e-commerce system will send a list of images to be displayed to the users or purchase histories and/or wish list of users to the social networking system may depend on an agreement that may exist between the social networking system and the at least one e-commerce system.

Provided that the information received from the e-commerce system is the user's purchase history and/or wish list and not a list of recommended images, then the process determines which images to recommend to be displayed to the user based on the information from the e-commerce system (block 450). Note that, if there is more than one purchase history and/or wish list for the user (i.e., the social networking system has received information related to the user from a plurality of e-commerce systems), then all the purchase histories and/or wish lists for the user will be taken into consideration when the social networking system is determining which images to recommend.

In any event, whether the recommended images are determined by the e-commerce system or by the social networking system, before they are sent to be displayed to the user, the process may determine whether it is advisable to do so. Therefore, the process may enquire as to whether the user wants to see the recommended images before actually sending the recommended images to be displayed to the user (block 460). If the user does not want to see the recommended images then the process terminates (block 490). If instead, the user would like to see the recommended images, the process re-organizes the images that were sent to be displayed to the user to include the recommended images (block 470). The process then sends the re-organized images to the client system to be displayed to the user (block 480) before the process ends (block 490).

In the case where the social networking system receives information about the user from two e-commerce systems, for example, and the information from one of the e-commerce system is a list of recommended images and the information from the other e-commerce system is a purchase history and/or wish list, the social networking system may decide to take into consideration the list of recommended images when determining the recommended images to display to the user. Alternatively, the social networking system may ignore the list of recommended images from the one e-commerce system when determining the recommended images. In another alternative scenario, the social networking may only take into consideration the recommended images received from the one e-commerce system. In any case, which alternative scenario that the social networking system decides to implement may depend on the agreement that exists between the social networking system and each one of the e-commerce systems.

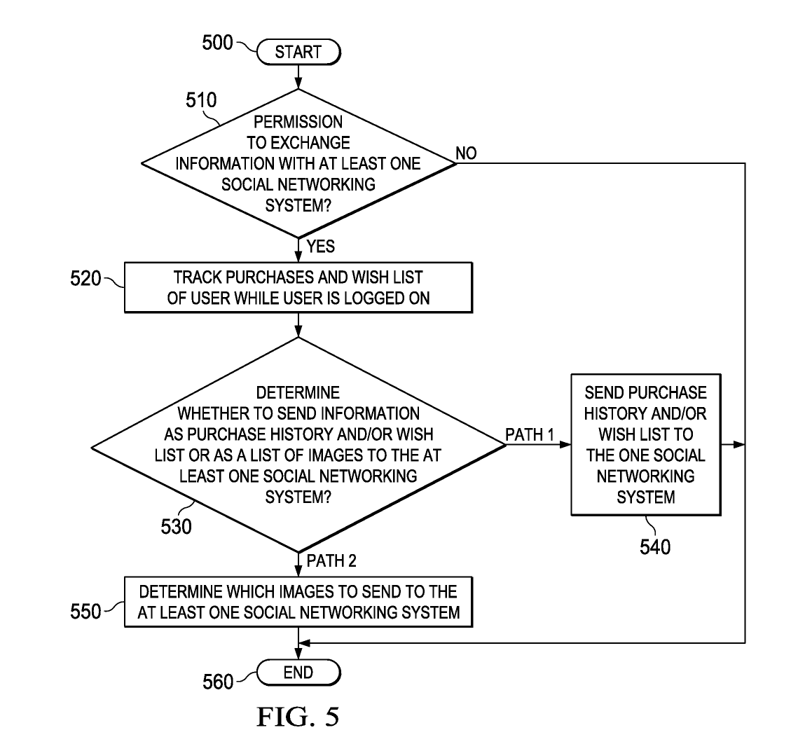

FIG. 5 is a flowchart of a process that may be used by an e-commerce system to send information about users to a social networking system, according to an illustrative embodiment. The process starts when the user is logged onto the e-commerce system (block 500). At that point, the process makes a determination as to whether the user has given permission for the e-commerce system to exchange information related to the user with at least one social networking system (block 510). If not, then the process terminates (block 560). If the user has given permission for the exchange of information, then the process may begin to track purchases that the user makes and/or items that the user may put on a wish list for the purpose of exchanging that information with the at least one social networking system. So long as the user remains logged onto the e-commerce system, the process will continue to track the user (block 520).

When the user logs off the e-commerce system, the process makes a determination as to whether to send the information to the at least one social networking system in the form of a list of images or purchase history and/or wish list (block 530). As mentioned above, if the agreement between the at least one social networking system and the e-commerce system is for the e-commerce system to merely send purchase histories and/or wish lists to the at least one social networking system, then the e-commerce system may send the purchase history and/or wish list the user may have on the e-commerce system to the at least one social networking system (block 540) by following path 1 before the process ends (block 560). If, on the other hand, the agreement is for the e-commerce system to send recommended images to the e-commerce system, then the process may determine based on the purchase history and/or wish list and/or location and/or travel patterns and other suitable types of information for the user which images to send to the at least one social networking system to display to the user (block 550) by following path 2 before the process ends (block 560).

As discussed above, in certain cases, the at least one social networking system may send to the e-commerce system a user's purchase history and/or wish list from one or more other e-commerce sites. If so, the e-commerce system may take into consideration those purchase histories and/or wish lists when determining which images to send to the at least one social networking system.

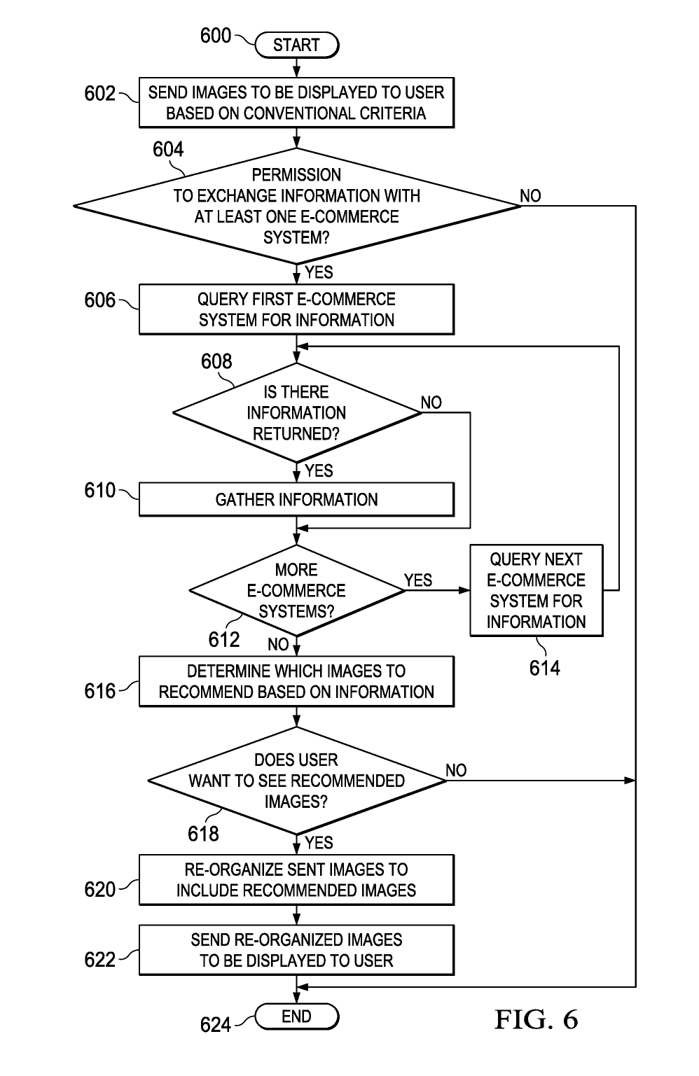

FIG. 6 is a flowchart of an alternative process that may be used by a social networking system to send images to be displayed to a user at a client system, according to an embodiment. The process starts when the user is logged onto the networking system (block 600). At that point, images of items that are usually displayed to the user based on conventional criteria (i.e., user preferences, user profile, search and browsing histories of the user and the like) are sent to the client system to be displayed to the user (block 602). The process then makes a determination as to whether the user has given permission for the social networking system to exchange information such as purchase history, wish list etc. of the user with at least one e-commerce system (block 604). If not, the process terminates (block 624). If, on the other hand, the user has given permission for the exchange of information, then the social networking system queries the first e-commerce system for the information (block 606). The process then determines whether information is returned in response to the query (block 608). If so, the process gathers up the information (block 610) and goes on to block 612. If there is no information returned in response to the query, the process jumps to block 612.

At block 612, the process determines whether there are more e-commerce systems to query. If so, the process queries the next e-commerce system (block 614) before returning back to block 608. If there are not anymore e-commerce systems to query, the process determines which images to recommend to be displayed to the user based on the information gathered (block 616). Then the process determines whether the user is interested in seeing the recommended images (block 618). If the user is not interested in seeing the recommended images, the process terminates (block 624). If the user is interested in seeing the recommended images, the process re-organizes the images that were sent earlier to the user to include the recommended images (block 620). The process then sends the re-organized images to be displayed to the user (block 624) before the process ends (block 626).

The descriptions of the various embodiments of the present invention have been presented for purposes of illustration, but are not intended to be exhaustive or limited to the embodiments disclosed.

For example, instead of obtaining users' purchase histories from the e-commerce sites, the social networking sites may obtain the information from the users themselves. Specifically, a user could provide access to his or her e-mail messages to a social networking site or upload the e-mail messages onto the social networking site. The social networking site may then scan the user's e-mail messages for order shipments, confirmation notes, or other types of information to obtain the user's order history. Note that in the case of social networking sites owned by companies such as Google, the social networking sites may, through their parent companies, already have access to the user's e-mail messages (i.e., a gmail account) and thus may scan the users' email messages for order shipments, confirmation notes, or other types of information in real time.

Further, the users' order histories may be gleaned from shipment manifests of delivery companies, such as Federal Express (FedEx), United Postal Service (UPS), or the United States Post Office or any other postal services. Specifically, the users' order histories may be obtained from any delivery company that uses shipment manifests for insurance purposes or otherwise to determine what is in each delivered box.

Thus, many modifications and variations will be apparent to those of ordinary skill in the art without departing from the scope and spirit of the described embodiments.

The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method of re-organizing images to be displayed to a user comprising:
sending the images to be displayed to the user during a browsing session, the images being organized based on a profile of the user;
receiving a request from the user for recommended images, the recommended images being based on a purchase history of the user;
responsive to the received request, re-organizing the sent images to include the recommended images; and
sending the re-organized images to be displayed to the user.

2. The computer-implemented method of claim 1, wherein the purchase history includes a wish list.

3. The computer-implemented method of claim 2, wherein the profile is based on a group consisting of preferences, browsing history, search history, location and travel pattern of the user.

4. The computer-implemented method of claim 2, wherein the purchase history is from an e-commerce site.

5. The computer-implemented method of claim 2, wherein the purchase history is from a plurality of e-commerce sites.

6. The computer-implemented method of claim 2, wherein the recommended images are from an e-commerce site.

7. The computer-implemented method of claim 6, wherein the purchase history is from a plurality of e-commerce sites.

8. A computer system for re-organizing images to be displayed to a user comprising:
at least one storage system for storing code data; and
at least one processor for processing the stored code data to:
send the images to be displayed to the user during a browsing session, the images being organized based on a profile of the user,
receive a request from the user for recommended images, the recommended images being based on a purchase history of the user,
responsive to the received request, re-organize the images sent to include the recommended images, and
send the re-organized images to be displayed to the user.

9. The computer system of claim 8, wherein the purchase history includes a wish list.

10. The computer system of claim 9, wherein the profile is based on a group consisting of preferences, browsing history, search history, location and travel pattern of the user.

11. The computer system of claim 9, wherein the purchase history is from an e-commerce site.

12. The computer system of claim 9, wherein the purchase history is from a plurality of e-commerce sites.

13. The computer system of claim 9, wherein the recommended images are from an e-commerce site.

14. The computer system of claim 13, wherein the purchase history is from a plurality of e-commerce sites.

15. A computer program product for re-organizing images to be displayed to a user, the computer program product comprising a computer-readable storage medium having program instructions embodied therewith, the instructions executable by a processor to cause the processor to:
send the images to be displayed to the user during a browsing session, the images being organized based on a profile of the user;
receive a request from the user for recommended images, the recommended images being based on a purchase history of the user;
responsive to the received request, re-organize the images sent to include the recommended images; and
send the re-organized images to be displayed to the user.

16. The computer program product of claim 15, wherein the purchase history includes a wish list.

17. The computer program product of claim 16, wherein the purchase history is from an e-commerce site.

18. The computer program product of claim 16, wherein the purchase history is from a plurality of e-commerce sites.

19. The computer program product of claim 16, wherein the recommended images are from an e-commerce site.

20. The computer program product of claim 19, wherein the purchase history is from a plurality of e-commerce sites.
